(19) United States
(12) Patent Application Publication
(10) Pub. No.: US 2003/0016784 A1
(43) Pub. Date: Jan. 23, 2003

(54) Device for the reflection of x-rays

(76) Inventors: Carsten Michaelsen, Geesthacht (DE); Rudiger Bormann, Rosengarten (DE); Michael Stormer, Hamburg (DE)

Correspondence Address: KLAUS J. BACH & ASSOCIATES, PATENTS AND TRADEMARKS, 4407 TWIN OAKS DRIVE, MURRYSVILLE, PA, 15668, US

(21) Appl. No.: 10/197,225

(22) Filed: Jul. 17, 2002

(30) Foreign Application Priority Data
Jul. 18, 2001 (DE) 101 34 267.5

(51) Int. Cl. G01N 23/20

(52) U.S. Cl. 378/70

(57) ABSTRACT

In a device for the reflection of x-rays comprising at least one x-ray reflecting element, the element is either coated with a corrosion resistant layer or the element includes an additive which makes the element corrosion resistant.

### BACKGROUND OF THE INVENTION

The invention relates to a device for the reflection of x-rays comprising at least one x-ray reflecting element.

Devices for the reflection of x-rays, generally called x-ray reflectors, have been employed for many years in various scientific, technical and practical areas, particularly for the redirection and for monochromatization of x-rays. Certain x-ray reflectors additionally improve the effectiveness of x-ray apparatus. Devices for the reflection of x-rays are based on crystals, total reflectors and multi-layer structures. The multi-layer structures are used particularly for the monochromatization of x-rays.

During the use of devices for the reflection of x-rays, it has been observed that the reflectors tended to rapidly corrode when in contact with a corrosive medium such as air, moisture and industrial waste gases. It has been found that, when subjected to intensive x-radiation, the reflectors lost their reflectivity and were even totally destroyed within a few days or weeks.

As reason for such rapid corrosion of the devices, it was found that the air molecules in the medium surrounding the device were ionized so that ozone and elemental oxygen was formed. This oxygen oxidized the surface of the x-ray reflecting elements aggressively and very rapidly. The oxygen forms with the material of the reflectors oxide islands. As a result, cracks occur whereby the surface becomes so rough that the roughness can be readily seen. With increasing roughness, the x-ray reflectivity of the reflector elements drops. Finally, the oxide islands lose their adherence to the x-ray reflector element and chip-off. As a result, the x-ray reflecting element is destroyed and the x-ray optically active surface of the element is completely destroyed. Under different corrosive conditions, other destruction mechanisms of the x-ray reflecting elements have been observed.

It is therefore the object of the present invention to provide a device for the reflection of x-rays wherein the x-ray reflecting surfaces remain free of corrosion even when in contact with corrosive media so that the reflection capability of the x-ray reflecting element remains in effect over long periods even when subjected to intense x-radiation. The manufacturing of such an element should also be relatively easy and the costs should not be substantially higher than for conventional x-ray reflector elements.

### SUMMARY OF THE INVENTION

In a device for the reflection of x-rays comprising at least one x-ray reflecting element, the element is either coated with a corrosion resisting layer or the element includes an additive which makes the element corrosion resistant.

With the arrangement according to the invention, the device is made corrosion-resistant in a simple manner without the need for changing the x-ray apparatus in connection with which the device according to the invention is utilized. The device according to the invention can be used of course not only with new apparatus but also existing apparatus can be equipped with devices according to the invention. The corrosion resistant layer can be deposited on the x-ray reflecting elements in a simple manner by known coating procedures such as the PVD process or the CVD process. These processes are equally suitable for coating x-ray reflecting elements also at a later time, that is, after the manufacture of the elements.

In an advantageous embodiment of the device, the corrosion-resistant layer is amorphous. This has the advantage that no grain limits are available as possible reaction paths. That is, the amorphous layer should preferably be a continuous layer.

In order to affect the (x-ray) properties of the x-ray reflecting element as little as possible the corrosion resistant layer should have a low density, that is, the x-ray optical properties of the corrosion resistant layer should have low absorption.

Preferably, the thickness of the corrosion resistant layer is essentially in the range of 1 to 10³ nm. It is particularly advantageous if the corrosion resident layer has a thickness of 5 to 50 nm. The selection of the thickness of the corrosion resistant layer depends also on the x-ray properties of the x-ray reflecting material.

Corrosion resistant layers of a metal oxide have been found to be particularly advantageous. The layers should be thermodynamically extremely stable so that reactions with the corrosive medium surrounding the device are further suppressed.

As metal oxide aluminum oxide has been found to be particularly advantageous. Also, aluminum oxide can be particularly easily deposited on the x-ray reflecting element by the PVD procedure described above.

In another way for solving the object, no corrosion-resistant layer is deposited on the x-ray reflecting element; rather the element includes an additive by which the x-ray reflecting element as a whole becomes corrosion resistant.

In this way, the corrosion resistance can be installed, so to say, in the x-ray reflecting device during its manufacture.

This may be achieved in various ways. Firstly, the element and the additive may form an alloy; secondly, the element and the additive may be a mixture.

As alloy components, particularly Al and/or Cr containing alloy components are suitable which protect from oxidation particularly effectively since they form with the ambient air a passive oxide coating.

Preferred alloy components are Ni—Cu, Ni—Cr— and Ni—Cr—Al—Y alloy components. Often the devices for the reflection of x-rays include x-ray reflecting elements which include nickel. In accordance with the advantageous embodiment, the element nickel is replaced by the corrosion resistant nickel alloys mentioned above. It has been found that the x-ray reflecting properties deteriorate only insignificantly thereby.

Finally, it is possible to combine the two solutions, that is, to deposit a corrosion resistant layer on an x-ray reflecting element which is an alloy or a mixture with an additive that makes the x-ray reflecting element corrosion resistant.

What is claimed is:

1. A device for reflecting x-rays, comprising at least one x-ray reflecting element having a corrosion resistant layer deposited thereon.

2. A device according to claim 1, wherein said corrosion-resistant layer is amorphous.

3. A device according to claim 1, wherein said corrosion-resistant layer has a low density.

4. A device according to claim 1, wherein said corrosion-resistant layer has a thickness of 1 to 10³ nm.

5. A device according to claim 1, wherein said corrosion-resistant layer consists of a metal oxide.

6. A device according to claim 5, wherein said metal oxide is aluminum oxide.

7. A device for reflecting x-rays comprising at least one x-ray reflecting element including an additive which makes the corrosion reflecting element corrosion resistant.

8. A device for reflecting according to claim 7, wherein said element forms with the additive an alloy.

9. A device for reflecting according to claim 8, wherein said alloy contains at least one of Al and Cr.

10. A device for reflecting according to claim 8, wherein said alloy includes at least one of a Ni—Cu, a Ni—Cr and a Ni—Cr—Al—Y alloy.
